(19) United States
(12) Patent Application Publication
(10) Pub. No.: US 2010/0246400 A1
(43) Pub. Date: Sep. 30, 2010

(54) COMMUNICATION DEVICE AND METHOD

(75) Inventors: Kazuo ONISHI, Kanagawa (JP); Hiroshi Shikanai, Kanagawa (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/748,337

(22) Filed: Mar. 26, 2010

(30) Foreign Application Priority Data
Mar. 26, 2009 (JP) 2009-077262
Mar. 26, 2009 (JP) 2009-077267

(51) Int. Cl. H04L 12/56

(52) U.S. Cl. 370/235

(57) ABSTRACT

Provided is a communication device and method that is capable of utilizing ECN functions effectively. The communication device includes: a first communication unit 11; a second communication unit 12; a first determination unit 13 that determines whether a PC 101 to which the first communication unit 11 is connected and a PC 301 on a network 202 side communicating with the second communication unit 12 have a congestion control function against data congestion; a second determination unit 14 that determines whether data congestion is occurring in the PC 301; and a control unit 15 that adds first control data for activating the congestion control function provided in the PC 101 to data to be transmitted to the PC 101, and that causes the first communication unit 11 to transmit the data, in a case in which it is determined that the device to which the first communication unit 11 is connected has the congestion control function, but the PC 301 communicating with the second communication unit 12 does not have the congestion control function, and it is determined that data congestion is occurring in the PC 301.

This application is based on and claims the benefit of priority from Japanese Patent Application No. 2009-077262, filed on 26 Mar. 2009 and Application No. 2009-077267, filed on 26 Mar. 2009, the content of which is incorporated herein by reference.

### BACKGROUND OF THE INVENTION

1. Field of the Invention

The present invention relates to a communication device and method having a function to control data congestion.

2. Related Art

Data communication is performed in compliance with a predetermined protocol (for example, TCP (Transmission Control Protocol)) among electronic devices that perform communication via a network.

Here, in a case in which data congestion (overcrowding) occurs on the network, and such a situation is left uncontrolled, a part of transmitted data will be discarded in a router.

Here, one TCP congestion control method for avoiding such discarding of data is ECN (Explicit Congestion Notification) (for example, refer to Patent Document 1).

ECN has been defined in RFC3168 as a TCP enhanced function, and is beginning to be provided in an OS (Operating System) of some electronic devices as well.

ECN is a technique, in which, when a router has detected congestion, the router transmits the fact that the congestion has been detected to an electronic device on a data transmitting side, and make the electronic device control a data transmission rate, thereby avoiding congestion.

More specifically, in an electronic device that is compliant with ECN, in a case in which congestion (jam) is occurring, a data transfer rate is slowed down by controlling a window size to be small; on the other hand, in a case in which congestion is not occurring, the data transfer rate is accelerated by controlling the window size to be large as usual, thereby making it possible to perform data communication efficiently without causing data to be discarded.

Patent Document 1: Japanese Unexamined Patent Application, First Publication No. 2004-357177

### SUMMARY OF THE INVENTION

An object of the present invention is to provide a communication device and method that is capable of utilizing ECN functions effectively.

In order to solve the aforementioned problem, a communication device according to the present invention is configured with: a first communication unit that is connected to an external device and relay data; a second communication unit that transmits data received from the first communication unit to a network side, and transmits data received from the network side to the first communication unit; and a processing unit that confirms whether a congestion control function against data congestion is provided to the external device to which the first communication unit is connected and an another party's device on the network side communicating with the second communication unit, in a casein which any one of the devices has the congestion control function, and congestion is occurring in an other one of the devices, the processing unit transmits control data for activating the congestion control function to the other one of the devices.

Moreover, in the communication device, the processing unit is preferably configured with: a first determination unit that determines whether the external device to which the first communication unit is connected and the another party's device on the network side communicating with the second communication unit have the congestion control function against data congestion, based on data received via the first communication unit and data received via the second communication unit; a second determination unit that determines whether data congestion is occurring in the another party's device communicating with the second communication unit, based on data received via the second communication unit; and a control unit that adds, to data transmitted via the first communication unit to the external device, first control data for activating the congestion control function provided to the external device, and causes the first communication unit to transmit the data, in a case in which the first determination unit determines that the device to which the first communication unit is connected has the congestion control function, but the another party's device communicating with the second communication unit does not have the congestion control function, and the second determination unit determines that data congestion is occurring in the another party's device communicating with the second communication unit.

In addition, the communication device is preferably configured such that the first determination unit determines whether the external device to which the first communication unit is connected has the congestion control function based on whether the data received via the first communication unit includes information indicating that the congestion control function is provided, and determines whether the another party's device communicating with the second communication unit has the congestion control function based on whether the data received via the second communication unit includes information indicating that the congestion control function is provided.

Furthermore, the communication device is preferably configured such that the second determination unit determines whether data congestion is occurring in the another party's device communicating with the second communication unit based on whether a timing of receiving data via the second communication unit is delayed for more than a predetermined time.

Moreover, the communication device is preferably configured such that the control unit deletes the information included in the data received via the first communication unit, the information indicating that the congestion control function is provided, and controls the second communication unit to transmit the data from which the information indicating that the congestion control function is provided has been deleted, in a case in which the first determination unit determines that the external device to which the first communication unit is connected has the congestion control function, and that the another party's device communicating with the second communication unit does not have the congestion control function.

In addition, the communication device is preferably configured such that, after transmitting the first control data to the external device via the first communication unit, in a case in which the first communication unit has received, from the external device, second control data indicating that the congestion control function has been exercised, the control unit does not transmit the first control data when transmitting data via the first communication unit.

Furthermore, the communication device is preferably configured such that, in a case in which the first determination unit determines that the external device to which the first communication unit is connected and the another party's device communicating with the second communication unit have the congestion control function, the control unit transmits data without changing the data, both in a case of transmitting the data received via the second communication unit to the external device to which the first communication unit is connected, and in a case of transmitting the data received via the first communication unit to the another party's device to which the second communication unit is connected.

Moreover, in the communication device, the processing unit is preferably configured with: a first token generating unit that generates a token configured with a predetermined data amount; a first token storing unit that stores the token; a first detecting unit that detects an amount of tokens stored in the first token storing unit; a first control unit that determines whether an amount of tokens detected by the first detecting unit has reached a first threshold value, and in a case in which the first control unit determines that the amount of tokens has reached the first threshold value, the first control unit controls such that the data received via the first communication unit is transmitted, for only an amount corresponding to the amount of tokens, to the network via the second communication unit; and a first determination unit that determines whether the external device to which the first communication unit is connected has the congestion control function against data congestion, and in a case in which the first control unit determines that an amount of tokens detected by the first detecting unit is no more than a second threshold value, which is smaller than the first threshold value, and the first determination unit determines that the external device to which the first communication unit is connected has the congestion control function, the first control unit adds first control information for activating the congestion control function to data to be transmitted via the first communication unit, and causes the first communication unit to transmit the data.

In addition, the communication device is preferably configured such that the first determination unit determines whether the device to which the first communication unit is connected has the congestion control function, based on whether the data received via the first communication unit includes second control information indicating that the congestion control function is provided.

Furthermore, the communication device is preferably configured such that, in a case in which the first communication unit has received, from the external device connected thereto, data to which third control information has been added, indicating that a congestion window has been reduced, the first control unit deletes the third control information from the data, and transmits the data, from which the third control information has been deleted, to the network via the second communication unit.

Moreover, in the communication device, the processing unit is preferably configured with: a second token generating unit that generates a token configured with a predetermined data amount; a second token storing unit that stores the token; a second detecting unit that detects an amount of tokens stored in the second token storing unit; a second control unit that determines whether an amount of tokens detected by the second detecting unit has reached a first threshold value, and in a case in which the second control unit determines that the amount of tokens has reached the first threshold value, the first control unit controls such that the data received via the second communication unit is transmitted, for only an amount corresponding to the amount of tokens, to the network via the first communication unit; and a second determination unit that determines whether the another party's device on the network side has the congestion control function against data congestion, and in a case in which an amount of tokens detected by the second detecting unit is no more than a second threshold value, which is smaller than the first threshold value, and the second determination unit determines that the another party's device on the network side has the congestion control function, the second control unit adds fourth control information for activating the congestion control function to the data received via the first communication unit, and causes the second communication unit to transmit the data.

In addition, the communication device is preferably configured such that the second determination unit determines whether the device on the network side has the congestion control function, based on whether the data received via the second communication unit includes fifth control information indicating that the congestion control function is provided.

Furthermore, the communication device is preferably configured such that, in a case in which the second communication unit has received, from the device on the network side, data to which sixth control information has been added, indicating that a congestion window has been reduced, the second control unit deletes the sixth control information from the data, and transmits the data, from which the sixth control information has been deleted, to the external device via the first communication unit.

According to the present invention, ECN can be utilized effectively.

In order to solve the aforementioned problem, a communication method according to the present invention is configured with:
a relaying data from an external device connecting via the first communication unit; a transmitting data received from the first communication unit to a network side via the second communication unit, and data received from the network side to the first communication unit; and a processing that confirms whether a congestion control function against data congestion is provided to the external device to which the first communication unit is connected and an another party's device on the network side communicating with the second communication unit, in a casein which any one of the devices has the congestion control function, and congestion is occurring in an other one of the devices, the processing unit transmits control data for activating the congestion control function to the other one of the devices.

### BRIEF DESCRIPTION OF THE DRAWINGS

FIG. 1 is a diagram showing an aspect in which a communication device is connected to a PC, and is connected to a network;

FIG. 2 is a sequence chart illustrating a TCP connection establishment sequence;

FIG. 3 is a sequence chart illustrating a congestion control sequence by way of ECN;

FIG. 4 is a block diagram showing functions of a communication device according to the present invention;

FIG. 5 is a schematic diagram showing a configuration of a TCP header;

FIG. 6 is a sequence chart illustrating a TCP connection establishment sequence in a case in which a PC on a data transmitting side is compliant with ECN and a PC on a data receiving side is not compliant with ECN;

FIG. 7 is a sequence chart illustrating a TCP connection establishment sequence in a case in which both of the PC on the data transmitting side and the PC on the data receiving side are compliant with ECN;

FIG. 8 is a sequence chart illustrating a TCP connection establishment sequence in a case in which the PC on the data transmitting side is not compliant with ECN;

FIG. 9 is a sequence chart illustrating a congestion control sequence by way of ECN performed between the PC on the data transmitting side and the communication device;

FIG. 10 is a block diagram showing a first function of the communication device according to the present invention;

FIG. 11 is a block diagram showing a second function of the communication device according to the present invention;

FIG. 12 is a sequence chart illustrating a TCP connection establishment sequence in a case in which the PC connected to the communication device is compliant with ECN and the network side is not compliant with ECN;

FIG. 13 is a sequence chart illustrating a TCP connection establishment sequence in a case in which the PC connected to the communication device is not compliant with ECN and the network side is compliant with ECN;

FIG. 14 is a sequence chart illustrating congestion control operations by a PC in a case in which congestion has occurred on the network side; and

FIG. 15 is a sequence chart illustrating congestion control operations by the network side in a case in which congestion has occurred in the PC.

### DETAILED DESCRIPTION OF THE INVENTION

Embodiments of the present invention will be described in detail hereinafter.

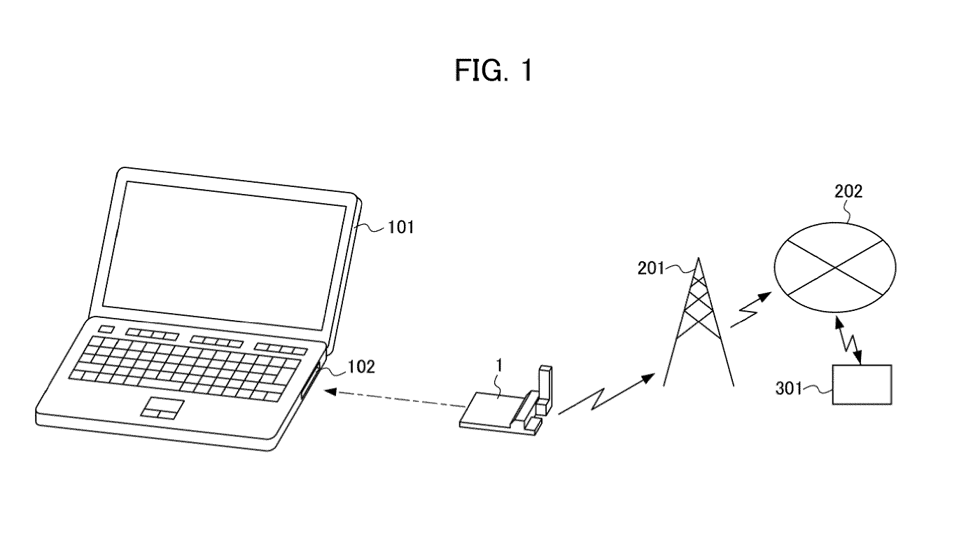

A communication device 1 according to the present embodiment is utilized as a PC card having an antenna for radio communication, and as shown in FIG. 1, for example, the communication device 1 is inserted into a card slot 102 of a PC (Personal Computer) 101, and is connected thereto, thereby being utilized by the PC 101 for connection to a network 202 (for example, the Internet) via a base station 201.

Firstly, a TCP peer is described.

In three-way handshaking (three-step connecting procedure), TCP peers negotiate with each other regarding whether being compliant with ECN.

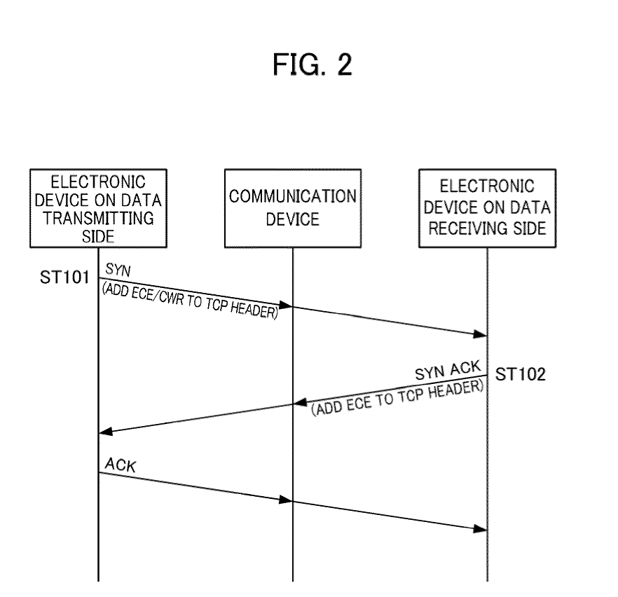

More specifically, as shown in FIG. 2, a TCP (ECN) connection establishment sequence is performed by an ECN-compliant electronic device on the transmitting side setting an ECE flag and a CWR flag to a TCP header of SYN and performing transmission (Step ST101), and an ECN-compliant electronic device on the receiving side settings an ECE flag to a TCP header of SYN/ACK and replying thereto (Step ST102).

In addition, a congestion control sequence by way of

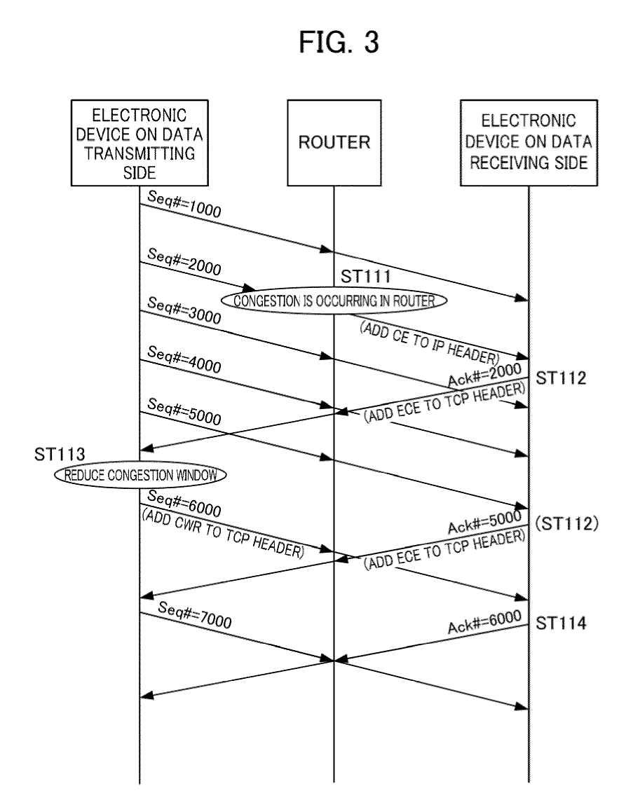

ECN is performed as shown in FIG. 3.

In a case in which a used amount of a buffer for accumulating packets that are waiting for transfer exceeds a certain threshold value, an ECN-compliant router determines that congestion is occurring in the network. Then, the ECN-compliant router sets a bit (CE: Congestion Experienced), which indicates that congestion is being experienced, to a ToS (Type of Service) field of an IP (Internet Protocol) header of a forward packet, and transfers the packet to the receiving side (Step ST111).

Upon receiving a packet in which CE has been set to an IP header, the electronic device on the receiving side sets an ECE (ECN-Echo) flag to a TCP header, and returns an acknowledgement to the transmitting side (Step ST112).

This response is continued until the electronic device on the receiving side receives a packet, in which a CWR (Congestion Window Reduced) flag has been set to a TCP header, from the electronic device on the transmitting side.

Upon receiving a packet in which an ECE flag has been set to a TCP header, the electronic device on the transmitting side determines that congestion is occurring, reduces a congestion window size to a threshold value (ssthresh) of a slow start, sets a CWR flag of a TCP header of the next packet, and transmits the packet (Step ST113).

Upon receiving a packet in which a CWR flag has been set, the electronic device on the receiving side stops setting an ECE flag of the subsequent acknowledge packet (Step ST114).

Embodiments of the present invention will be described in detail hereinafter.

### First Embodiment

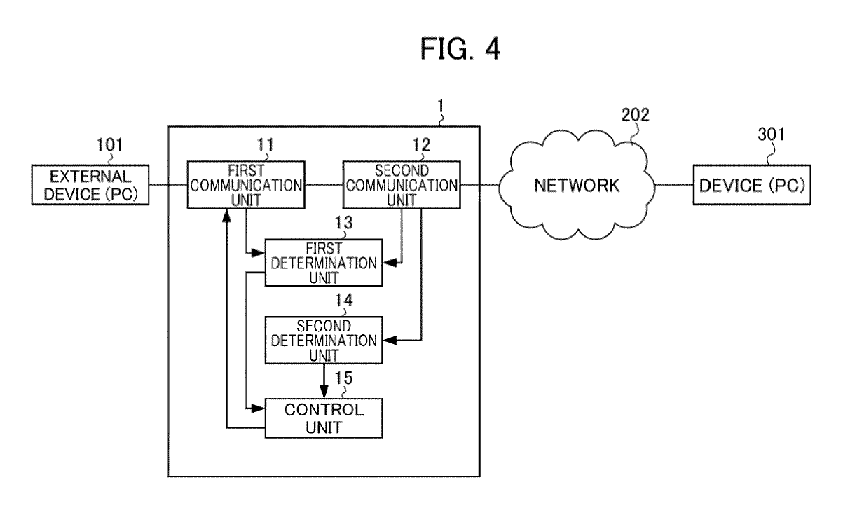

As shown in FIG. 4, the communication device 1 includes a first communication unit 11, a second communication unit 12, a first determination unit 13, a second determination unit 14 and a control unit 15.

It should be noted that the first determination unit 13, the second determination unit 14 and the control unit 15 comprehensively configure a processing unit.

The first communication unit 11 is connected to an external device (hereinafter referred to as a PC 101) to relay data.

More specifically, the first communication unit 11 is configured with a transmitting port that transmits data to the PC 101, and a receiving port that receives data transmitted from the PC 101.

The second communication unit 12 transmits data, which has been received via the first communication unit 11, to the network 202 side, and receives data from the network 202 side.

More specifically, the second communication unit 12 is configured with a transmitting port that transmits data to the network 202 side, and a receiving port that receives data transmitted from the network 202 side.

The first determination unit 13 determines whether the

PC 101 to which the first communication unit 11 is connected and an another party's device (hereinafter referred to as a PC 301) on the network 202 side communicating with the second communication unit 12 have a congestion control function against data congestion (based on data received via the first communication unit 11 and data received via the second communication unit 12).

The second determination unit 14 determines whether data congestion is occurring in the PC 301 communicating with the second communication unit 12 (based on data received via the second communication unit 12).

In a case in which the first determination unit 13 determines that the device to which the first communication unit 11 is connected has the congestion control function, but the PC 301 communicating with the second communication unit 12 does not have the congestion control function, and yet the second determination unit 14 determines that data congestion is occurring in the PC 301 communicating with the second communication unit 12, the control unit 15 adds first control data (for example, an ECE flag) for activating the congestion control function provided in the PC 101 to data transmitted via the first communication unit 11 to the PC 101, and causes the first communication unit 11 to transmit the data.

Here, a structure of a TCP header is described.

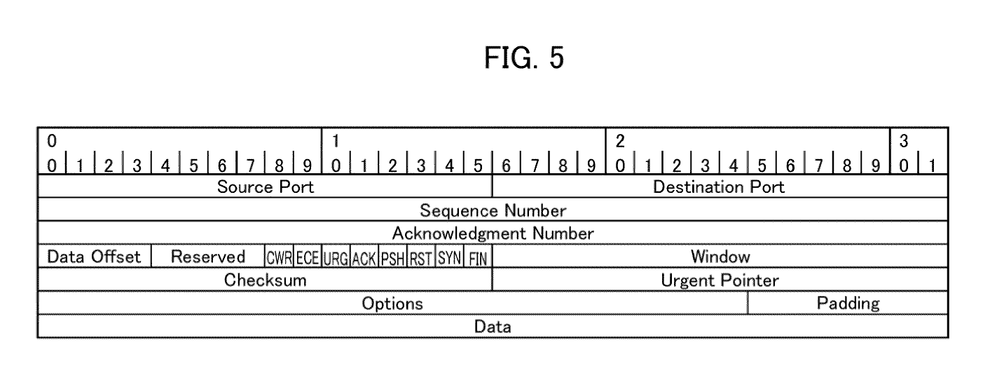

As shown in FIG. 5, the TCP header is configured with, in order from the top, Source Port (source port number), Destination Port (destination port number), Sequence Number (sequence number), Acknowledgment Number (acknowledgement number), Data Offset (data offset), Reserved (reserve), Control Bits (control bits), Window (window size), Checksum (check sum), Urgent Pointer (urgent pointer), Options (option) and Padding (padding).

Moreover, the control bits are configured with CWR (congestion window reduction) that notifies of reduction of a congestion window, ECE (ECN-Echo) that notifies another party's device of the occurrence of congestion, URG (urgency flag) that instructs an urgent pointer field to be used, ACK (acknowledgement flag) that indicates that a segment is waiting for acknowledgement, PSH (transfer forcing flag) that is transmitted as soon as becoming ready for reception, RST (reset flag) that indicates an instruction to reset communication when an incorrect packet has been received, SYN (synchronization flag) that indicates transfer of a top sequence number, and FIN (finishing transfer flag) that indicates finishing transmission or being ready for reception.

More specifically, the control unit 15 sets the ECE flag in the control bits of the TCP header to “1”, and transmits it from the first communication unit 11 to the PC 101.

In this way, in a case in which the network 202 side is not compliant with ECN, and the PC 101 is compliant with ECN, it is possible to make it appear to the PC 101 as if the network 202 side is compliant with ECN when establishing a session.

Accordingly, although it has not been conventionally possible to exercise the congestion control function of the PC 101 in a case in which the network 202 side is not compliant with ECN, it is possible to exercise the congestion control function of the PC 101 even if the network 202 side is not compliant with ECN according to the communication device 1.

In addition, the first determination unit 13 determines whether the PC 101 to which the first communication unit 11 is connected has the congestion control function, based on whether the data received via the first communication unit 11 includes information indicating that the congestion control function is provided, and determines whether the PC 301 communicating with the second communication unit 12 has the congestion control function, based on whether the data received via the second communication unit 12 includes information indicating that the congestion control function is provided.

More specifically, in a case in which an ECE flag and a CWR flag have been added in control bits of a TCP header included in data received via the first communication unit 11, the first determination unit 13 determines that the PC 101 has the congestion control function.

Furthermore, in a case in which an ECE flag and a CWR flag have been added in control bits of a TCP header included in data received via the second communication unit 12, the first determination unit 13 determines that the PC 301 has the congestion control function.

Moreover, the second determination unit 14 determines whether data congestion is occurring in the PC 301 communicating with the second communication unit 12, based on whether a delay of more than a predetermined time is occurring in a timing to receive data via the second communication unit 12 (a delay time of a response for transmitted data).

In data communication using TCP, a device transmits data by adding a sequence number (for example, Seq #=1000) to each TCP packet.

The purpose thereof is to confirm continuity of the packets. In addition, the device on the receiving side replies by assigning the same number to an acknowledgement (Acknowledge) number (for example, Acq #=1000) in order to notify the device on the transmitting side of the fact that a TCP packet has arrived.

The second determination unit 14 detects a time from transmitting data until receiving response data, and in a case in which the time exceeds a predetermined time, the second determination unit 14 determines that data congestion is occurring in the PC 301 communicating with the second communication unit 12.

Furthermore, in a case in which the first determination unit 13 determines that the PC 101 to which the first communication unit 11 is connected has the congestion control function, and that the PC 301 communicating with the second communication unit 12 does not have the congestion control function, the control unit 15 deletes information indicating that the congestion control function is provided, the information being included in the data received via the first communication unit 11, and transmits the data, from which the information indicating that the congestion control function is provided has been deleted, via the second communication unit 12.

Here, in a device that is not compliant with ECN, in a case in which portions of an ECE flag and a CWR flag of control bits of a TCP header are not in a state in which a flag is not set, i.e. not in a state of “0 (zero)”, the device determines that there is no conformity in terms of the standard, and discards the packets in which an ECE flag and a CWR flag have been set.

Accordingly, in the communication device 1, in a case in which it is determined that the network 202 side is not compliant with ECN, information indicating that the congestion control function is provided is deleted, i.e. portions of an ECE flag and a CWR flag of control bits of a TCP header are set to “0 (zero)”, and such data is transmitted to the network 202 side via the second communication unit 12.

This makes it possible to prevent packets from being discarded on the network 202 side.

Moreover, in a case in which the first communication unit 11 received, from the PC 101, second control data (CWR flag) indicating that the congestion control function has been exercised after the first communication unit 11 has transmitted the first control data (ECE flag) to the PC 101, the control unit 15 does not transmit the first control data when transmitting data by way of the first communication unit 11.

The PC 101 confirms that congestion is occurring on the network 202 side, reduces a congestion window, and outputs the second control data indicating it.

The communication device 1 transmits acknowledgement data to the PC 101 without setting an ECE flag to the data.

It should be noted that an amount of data that is output from the PC 101 will be reduced by reducing the congestion window.

In addition, after reducing the congestion window, the PC 101 gradually increases the congestion window in accordance with an amount defined by the standard, and restores the window width over time.

Furthermore, in a case in which the first determination unit 13 determines that both of the PC 101 to which the first communication unit 11 is connected and the PC 301 communicating with the second communication unit 12 have the congestion control function, the control unit 15 transmits data received via the second communication unit 12 to the PC 101 to which the first communication unit 11 is connected, and transmits data received via the first communication unit 11 to the PC 301 to which the second communication unit 12 is connected, without changing the data.

By operating in this way, the communication device 1 does not disturb the congestion control that is performed between the PC 101 and the PC 301, which are each compliant with ECN.

### TCP Connection Establishment Sequence (1)

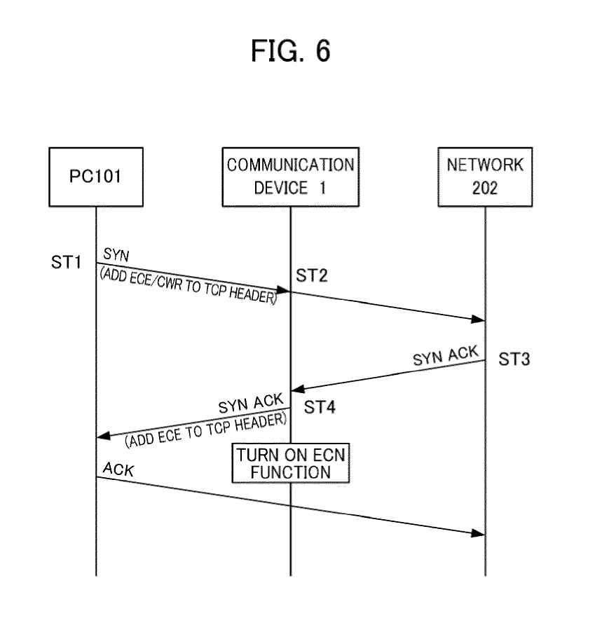

Here, a TCP connection establishment sequence in a case in which the PC 101 is compliant with ECN and the PC 301 is not compliant with ECN is described with reference to FIG. 6.

The PC 101 transmits an SYN (Synchronize) packet in order to perform TCP establishment (Step ST1).

An ECE flag and a CWR flag indicating compliance with

ECN have been added to the SYN packet.

Moreover, the communication device 1 stores the fact that the PC 101 is compliant with ECN by way of the SYN packet, and transfers the packet to the network 202 without change (Step ST2).

In response to the transmitted SYN packet, the network 202 transmits (returns) an SYN/ACK (SYN-Acknowledgement) packet (Step ST3).

Here, in a case in which the network 202 is not compliant with ECN, an ECE flag is not added.

In addition, since the PC 101 supports ECN, the communication device 1 adds an ECE flag to the header of the packet returned from the network 202, and transmits the packet to the PC 101 so as to change its own ECN into an active state (Step ST4).

In other words, in three-way handshaking for TCP establishment, in a case in which an ECE flag is not added to the control bits of the header of the TCP/IP packet received from the network 202, the communication device 1 changes ECN of the communication device 1 into an active state “ON”, and adds an ECE flag to the control bits of the header so as to make it appear to the PC 101 as if the network 202 has ECN, thereby changing ECN of the PC 101 into an active state.

Thereafter, ECN control can be performed between the

PC 101 and the communication device 1.

With such a configuration, the communication device 1 can make it appear to the PC 101 as if the network 202 supports ECN.

Accordingly, after the TCP connection establishment sequence, data communication can be performed by way of ECN control between the PC 101 and the communication device 1.

### TCP Connection Establishment Sequence (2)

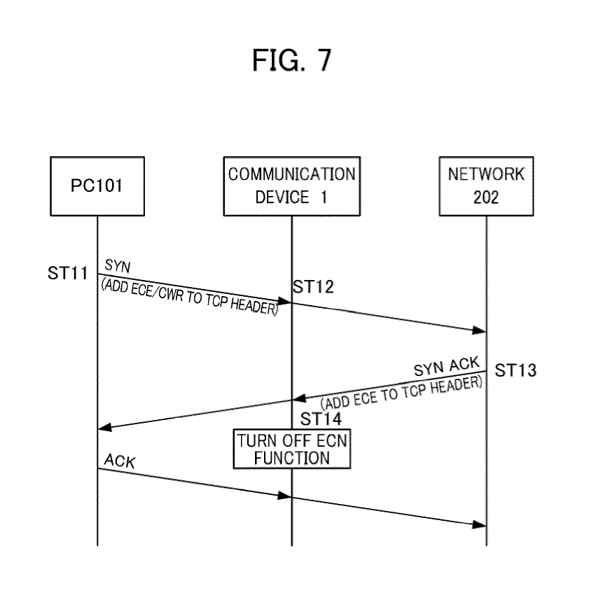

In addition, a TCP connection establishment sequence in a case in which the PC 101 is compliant with ECN and the network 202 side is also compliant with ECN is described with reference to FIG. 7.

The PC 101 transmits an SYN (Synchronize) packet in order to perform TCP establishment (Step ST11).

An ECE flag and a CWR flag indicating compliance with ECN have been added to the SYN packet.

The communication device 1 stores the fact that the PC is compliant with ECN by way of the packet, and transfers the packet to the network in the current state.

Moreover, the communication device 1 stores the fact that the PC 101 is compliant with ECN by way of the SYN packet, and transfers the packet to the network 202 in the current state (Step ST12).

In response to the transmitted SYN packet, the network 202 transmits (returns) an SYN/ACK (SYN-Acknowledgement) packet (Step ST13).

Here, in a case in which the network 202 is compliant with ECN, an ECE flag is added.

In addition, since both of the PC 101 and the network 202 are compliant with ECN, the communication device 1 changes its own ECN into an inactive state (Step ST14).

In other words, the communication device 1 does not change a header of a TCP packet in a TCP connection establishment sequence.

In other words, in three-way handshaking of TCP establishment, in a case in which an ECE flag has been added to a header portion of the TCP/IP packet received from the network 202, the communication device 1 changes its own ECN into an inactive state “OFF”, and does not change the header of the TCP packet when establishing a TCP connection.

With such a configuration, the communication device 1 does not disturb the congestion control that is performed between the PC 101 and the PC 301, which are compliant with ECN.

### TCP Connection Establishment Sequence (3)

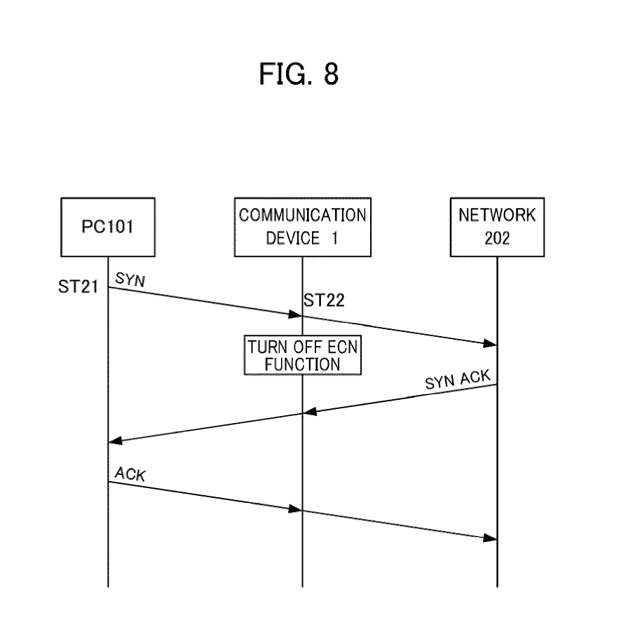

Furthermore, a TCP connection establishment sequence in a case in which the PC 101 is not compliant with ECN is described with reference to FIG. 8.

The PC 101 transmits an SYN (Synchronize) packet in order to perform TCP establishment (Step ST21).

Since the PC 101 is not compliant with ECN, an ECE flag and a CWR flag have not been added to the SYN packet.

The communication device 1 changes its own ECN into an inactive state, and transfers the SYN packet to the network 202 in the current state (Step ST22).

In other words, in three-way handshaking of TCP connection establishment, in a case in which an ECE flag and a CWR flag have not been added to a header portion of the TCP/IP packet received from the PC 101, the communication device 1 changes its own ECN into an inactive state “OFF”, and does not change the header of the TCP packet in a TCP connection establishment sequence.

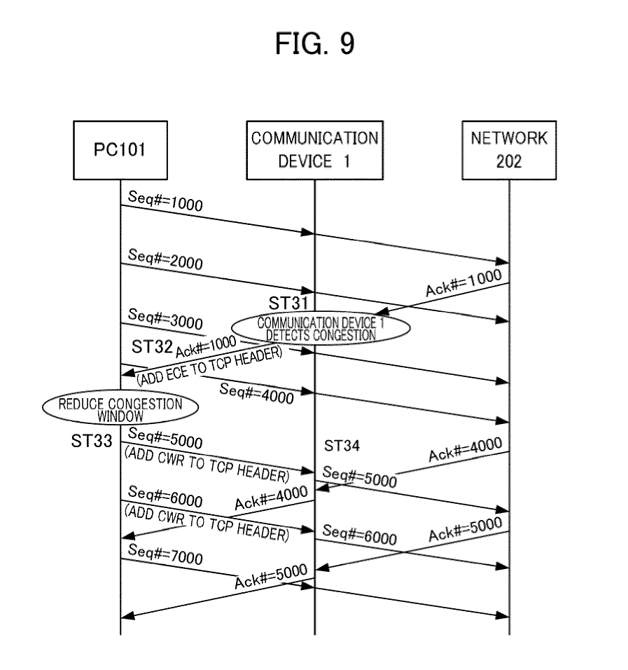

Next, a congestion control sequence by way of ECN performed between the PC 101 and the communication device 1 is shown in FIG. 9.

The communication device 1 detects that congestion is occurring in the network 202 based on a delay time T to receive ACK from the PC 101 (Step ST31).

Here, the delay time T is calculated from an average time in the most recent N moves and a threshold value.

The communication device 1 adds an ECE flag to a header of an ACK packet that is received from the network 202 side immediately after detecting the congestion, and transfers the packet to the PC 101 (Step ST32).

In a case in which the PC 101 receives a packet in which an ECE flag has been set to a TCP header, the PC 101 determines that congestion is occurring in the network 202 side, reduces the congestion window size to a threshold value (ssthresh) of a slow start, sets a CWR flag to a TCP header of the next packet in order to notify this fact, and transmits it (Step ST33).

Upon receiving the packet to which the CWR flag has been set, the communication device 1 does not set an ECE flag to the ACK packet received from the network 202, and transmits the packet to the PC 101 (Step ST34).

In this way, the communication device 1 changes its own

ECN into an active state or an inactive state depending on an ECN compliance status of the PC 101 and the network 202 side in a TCP connection establishment sequence.

In a case in which both of the PC 101 and the network 202 are compliant with ECN, the communication device 1 changes its own ECN into an inactive state, and utilizes an existing technique.

Moreover, in a case in which the PC 101 is compliant with ECN and the network 202 side is not compliant with ECN, the communication device 1 exercises ECN with the PC 101.

Accordingly, with the communication device 1 performing control by way of ECN with the PC 101 only, an effect of the congestion control by way of ECN can be obtained as an entire network even in a case in which the network 202 side is not compliant with ECN.

### Second Embodiment

Next, a token bucket mechanism is described first, before describing an example of using the token bucket mechanism.

In a network to which a plurality of electronic devices is connected, a function (hereinafter referred to as a traffic control function) to control a transmission rate (throughput) is provided on a mobile device side (device that is connected to an electronic device and is connected to the network), such that a particular electronic device does not consume radio resources excessively.

More specifically, the traffic control function has a token bucket mechanism in each of upstream and downstream sides, and is a function to respectively and independently control the throughput.

The token bucket mechanism has a packet buffer that accumulates packets that have been input, and a token bucket that accumulates tokens.

Tokens are supplemented to the token bucket at certain intervals, and the packets in the packet buffer cannot be output until a defined amount of tokens are accumulated.

Moreover, if packets corresponding to the amount of tokens are output, tokens of the corresponding amount are deducted from the token bucket.

In other words, the throughput of packets accumulated in the packet buffer is controlled by way of an amount of tokens to be supplemented to the token bucket in a unit time (token rate).

The token rate is not constant, since it dynamically changes due to a network environment and parameters that have been set inside the mobile device.

In an example of actual operation, control is performed such that the token rate is decreased in a case in which the network is being congested, and the token rate is increased in a case in which the network is not being congested.

In addition, the token rate is calculated based on the mean throughput of inputs into the packet buffer.

Accordingly, the token rate does not normally become a rate that is higher than the mean throughput.

Furthermore, there is a function (hereinafter referred to as a forcible token addition function) in which tokens are temporarily borrowed in advance, and transmission and reception are enabled without restriction as long as the data is up to a certain amount.

The forcible token addition function is a function that gives consideration to usability of a user performing communication of less than a certain amount only (a so-called light user).

Once the forcible token addition function operates, all the data, which have been accumulated in the packet buffer inside the mobile device, are transmitted at first, and the token rate is suppressed until the tokens that have been advanced are subsequently returned.

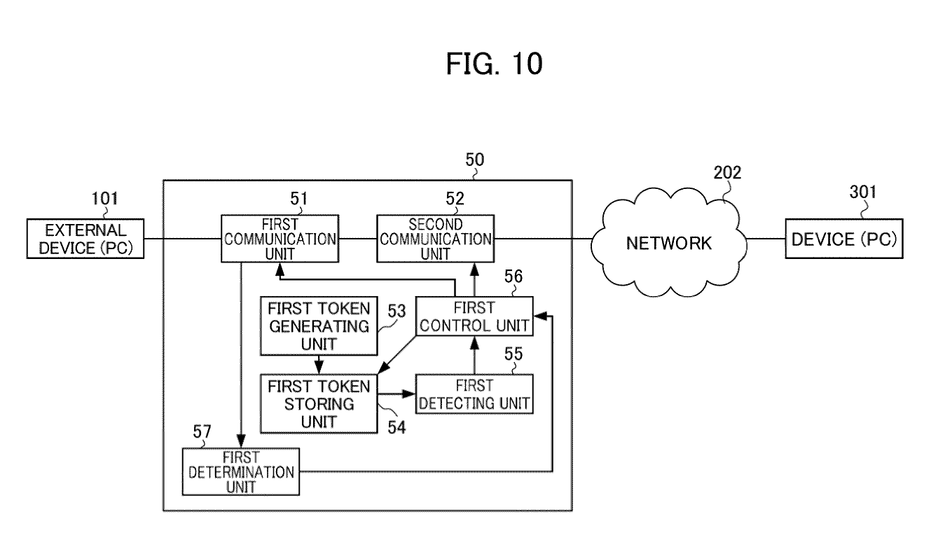

As shown in FIG. 10, a communication device 50 includes a first communication unit 51, a second communication unit 52, a first token generating unit 53, a first token storing unit 54, a first detecting unit 55, a first control unit 56 and a first determination unit 57.

It should be noted that the first token generating unit 53, the first token storing unit 54, the first detecting unit 55, the first control unit 56 and the first determination unit 57 comprehensively configure a processing unit.

The first communication unit 51 is connected to an external device (hereinafter referred to as a PC 101) to relay data.

More specifically, the first communication unit 51 is configured with a transmitting port that transmits data to the PC 101, and a receiving port that receives data transmitted from the PC 101.

The second communication unit 52 transmits data, which has been received via the first communication unit 51, to the network 202 side, and receives data from the network 202 side.

More specifically, the second communication unit 52 is configured with a transmitting port that transmits data to the network 202 side, and a receiving port that receives data transmitted from the network 202 side.

The first token generating unit 53 generates a token configured with a predetermined data amount.

The first token storing unit 54 stores tokens generated by way of the first token generating unit 53.

The first detecting unit 55 detects an amount of tokens stored in the first token storing unit 54.

The first control unit 56 determines whether an amount of tokens detected by the first detecting unit 55 has reached a first threshold value, and in a case in which it is determined that the amount of tokens has reached the first threshold value, the first control unit 56 controls such that the data received via the first communication unit 51 is transmitted to the network 202 by way of the second communication unit 52 for only an amount in accordance with the amount of tokens.

Here, a token is configured with a predetermined data amount per unit, and the tokens generated by way of the first token generating unit 53 are sequentially accumulated in the first token storing unit 54.

In addition, in a case in which the first control unit 56 determines that the tokens accumulated in the first token storing unit 54 have reached the first threshold value based on a detection result by a of the first detecting unit 55, the first control unit 56 controls such that data in accordance with the amount of the accumulated tokens is transmitted to the network 202 by way of the second the second communication unit 52.

Furthermore, after the data has been transmitted, the first control unit 56 reduces the tokens from the first token storing unit 54 for an amount in accordance with the transmitted data.

Moreover, the first determination unit 57 determines whether the PC 101 to which the first communication unit 51 is connected has the congestion control function against data congestion.

In a case in which an amount of tokens detected by the first detecting unit 55 is no more than a second threshold value, which is smaller than the first threshold value, and the first determination unit 57 determines that the PC 101 to which the first communication unit 51 is connected has the congestion control function, the first control unit 56 performs the following operations.

The first control unit 56 adds first control information for activating the congestion control function to the data transmitted via the first communication unit 51, and causes the first communication unit 51 to transmit the data.

It should be noted that the amount of tokens being no more than the second threshold value indicates a shortage of tokens.

In a case in which the state of the amount of tokens being no more than the second threshold value continues for more than a predetermined time, the first control unit 56 determines that congestion is occurring in the network 202 side, adds the first control information to data, and transmits the data to the PC 101.

In a case in which the PC 101 has received the first control information, the PC 101 reduces the congestion window.

Since the PC 101 reduces the congestion window in this way, the amount of data (amount of packets) that is output to the communication device 50 is reduced.

In addition, after reducing the congestion window, the

PC 101 gradually increases the congestion window in accordance with an amount defined by the standard, and restores the window width over time.

It should be noted that the structure of the TCP header has been previously described with reference to FIG. 5.

More specifically, in a case in which an amount of tokens detected by the first detecting unit 55 is no more than the second threshold value, which is smaller than the first threshold value, and the first determination unit 57 determines that the PC 101 to which the first communication unit 51 is connected has the congestion control function, the first control unit 56 sets an ECE flag (corresponding to the first control information) in control bits of a TCP header to “1” when the first control unit 56 transmits data to the PC 101.

In this way, in a case in which the PC 101 is compliant with ECN, the communication device 50 can perform congestion control with the PC 101 in accordance with an amount of tokens (token rate).

Accordingly, in a conventional configuration that performs traffic control by utilizing a token rate, a data input rate becomes greater than a data output rate for a communication device, and a packet buffer inside the communication device overflows, thereby leading to a risk of packet loss; however, in the communication device 50 according to the present embodiment, packet loss can be avoided.

Furthermore, in the communication device 50, since the packet loss can be avoided as described above, re-transmission of packets due to packet loss can be suppressed, and effective utilization of line resources can be achieved.

Moreover, in the communication device 50, since the need for the buffering processing for a packet buffer can also be eliminated, it is possible to achieve mitigation of the processing load as compared to the conventional configuration.

In addition, the first determination unit 57 determines whether the PC 101 to which the first communication unit 51 is connected has the congestion control function, based on whether the data received via the first communication unit 51 includes second control information indicating that the congestion control function is provided.

More specifically, in a case in which an ECE flag and a CWR flag (corresponding to the first control information) are set in control bits of a TCP header included in data received via the first communication unit 51, the first determination unit 57 determines that the PC 101 has the congestion control function.

Furthermore, in a case in which the first communication unit 51 has received data, from the PC 101 connected thereto, the data added with third control information indicating that the congestion window has been reduced, the first control unit 56 controls such that the third control information is deleted from the data, and the data from which the third control information has been deleted is transmitted to the network 202 by way of the second communication unit 52.

More specifically, in a case in which data is received from the PC 101, in which a CWR flag (corresponding to the third control information) of control bits of a TCP header has been set to “1”, the first control unit 56 controls such that data in which the CWR flag has been reset to “0 (zero)” is transmitted to the network 202.

With such a configuration, congestion control can be performed between the PC 101 and the communication device 50 without affecting the network 202 side.

### Third Embodiment

In the aforementioned second embodiment, the control of the communication device 50 has been described for a case in which congestion has occurred in the network 202 side when transmitting data from the PC 101 to the network 202 via the communication device 50.

In a third embodiment, control of the communication device 50 is described for a case in which congestion has occurred in the PC 101 when transmitting data from the PC 301 of the network 202 side to the PC 101 via the communication device 50.

It should be noted that the same reference numerals are assigned to the configurations and operations that are the same as those of the communication device 50 in the following description.

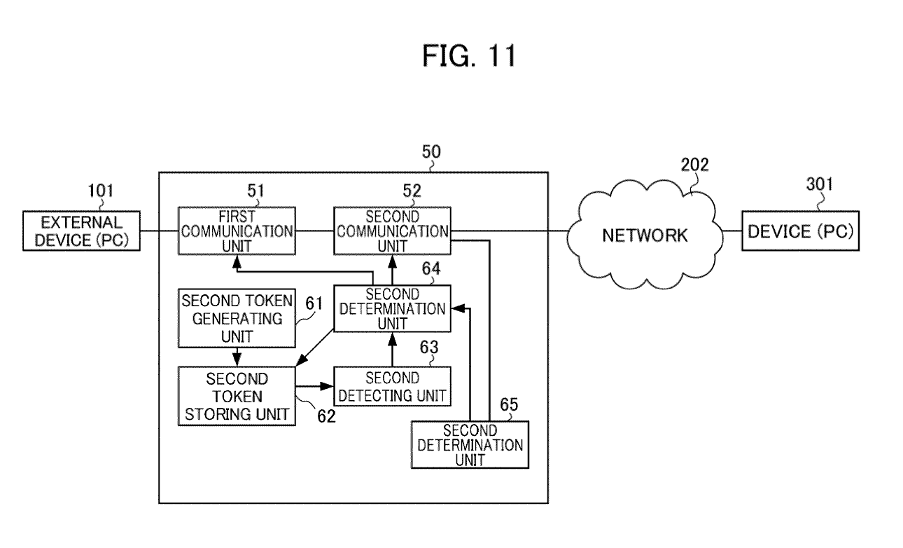

As shown in FIG. 11, the communication device 50 includes the first communication unit 51, the second communication unit 52, a second token generating unit 61, a second token storing unit 62, a second detecting unit 63, a second control unit 64 and a second determination unit 65.

It should be noted that the communication device 50 in the second embodiment may further include such a configuration.

Moreover, the second token generating unit 61, the second token storing unit 62, the second detecting unit 63, the second control unit 64 and the second determination unit 65 comprehensively configure a processing unit.

The first communication unit 51 is connected to the PC 101 to relay data.

More specifically, the first communication unit 51 is configured with a transmitting port that transmits data to the PC 101, and a receiving port that receives data transmitted from the PC 101.

The second communication unit 52 receives, from the network 202 side, data to be transmitted via the first communication unit 51, and transmits data, which has been received via the first communication unit 51, to the network 202 side.

More specifically, the second communication unit 52 is configured with a transmitting port that transmits data to the network 202 side, and a receiving port that receives data transmitted from the network 202 side.

The second token generating unit 61 generates a token configured with a predetermined data amount.

The second token storing unit 62 stores tokens generated by way of second token generating unit 61.

The second detecting unit 63 detects an amount of tokens stored in the second token storing unit 62.

The second control unit 64 determines whether an amount of tokens detected by the second detecting unit 63 reaches a first threshold value, and in a case in which it is determined that the amount of tokens has reached the first threshold value, the second control unit 64 controls such that the data received via the second communication unit 52 is transmitted to the PC 101 by way of the first communication unit 51 for only an amount in accordance with the amount of tokens.

In addition, in a case in which the second control unit 64 determines that the tokens accumulated in the second token storing unit 62 have reached the first threshold value based on a detection result by way of the second detecting unit 63, the second control unit 64 controls such that data in accordance with the amount of the accumulated tokens is transmitted to the PC 101 by way of the first communication unit 51.

Furthermore, after the data has been transmitted, the second control unit 64 reduces the tokens from the second token storing unit 62 for an amount in accordance with the transmitted data.

Moreover, the second determination unit 65 determines whether a device (hereinafter referred to as a PC 301) on the network 202 side has the congestion control function against data congestion.

With such a configuration, in a case in which an amount of tokens detected by the second detecting unit 63 is no more than the second threshold value, which is smaller than the first threshold value, and the second determination unit 65 determines that the PC 301 on the network 202 side has the congestion control function, the second control unit 64 adds fourth control information for activating the congestion control function to the data received via the first communication unit 51, and causes the second communication unit 52 to transmit the data.

It should be noted that the amount of tokens being no more than the second threshold value indicates the shortage of tokens.

In a case in which the state of the amount of tokens being no more than the second threshold value continues for more than a predetermined time, the second control unit 64 determines that congestion is occurring in the PC 101, sets an ECE flag (corresponding to the fourth control information) of control bits of a TCP header to “1”, the flag being added to data, and transmits the data to the network 202.

In a case in which the PC 301 has received the fourth control information, the PC 301 reduces the congestion window.

Since the PC 301 reduces the congestion window in this way, the amount of data (amount of packets) that is transmitted to the communication device 50 via the network 202 is reduced.

In addition, after reducing the congestion window, the PC 301 gradually increases the congestion window in accordance with an amount defined by the standard, and restores the window width over time.

In this way, in a case in which the PC 301 is compliant with ECN, the communication device 50 can perform congestion control with the PC 301 in accordance with an amount of tokens (token rate).

Accordingly, in a conventional configuration that performs traffic control by utilizing a token rate, a data input rate becomes greater than a data output rate for a communication device, and a packet buffer inside the communication device overflows, thereby leading to a risk of packet loss; however, in the communication device 50 according to the present embodiment, packet loss can be avoided.

Furthermore, in the communication device 50, since the packet loss can be avoided as described above, re-transmission of packets due to packet loss can be suppressed, and effective utilization of line resources can be achieved.

Moreover, in the communication device 50, since the need for the buffering processing for a packet buffer can also be eliminated, it is possible to achieve mitigation of the processing load as compared to the conventional configuration.

The second determination unit 65 determines whether the PC 301 on the network 202 side has the congestion control function, based on whether the data received via the second communication unit 52 includes fifth control information indicating that the congestion control function is provided.

More specifically, in a case in which an ECE flag and a CWR flag (corresponding to the fifth control information) are set in control bits of a TCP header included in data received via the second communication unit 52, the second determination unit 65 determines that the PC 301 has the congestion control function.

In addition, in a case in which the second communication unit 52 has received data, from the PC 301 on the network 202 side, the data added with sixth control information indicating that the congestion window has been reduced, the second control unit 64 controls such that the sixth control information is deleted from the data, and the data from which the sixth control information has been deleted is transmitted to the PC 101 by way of the first communication unit 51.

More specifically, in a case in which data is received from the PC 301, in which a CWR flag (corresponding to the sixth control information) of control bits of a TCP header data has been set to “1”, the second control unit 64 controls such that data in which the CWR flag has been reset to “0 (zero)” is transmitted to the PC 101.

With such a configuration, congestion control can be performed between the PC 301 and the communication device 50 via the network 202 without affecting the PC 101.

### TCP Connection Establishment Sequence (4)

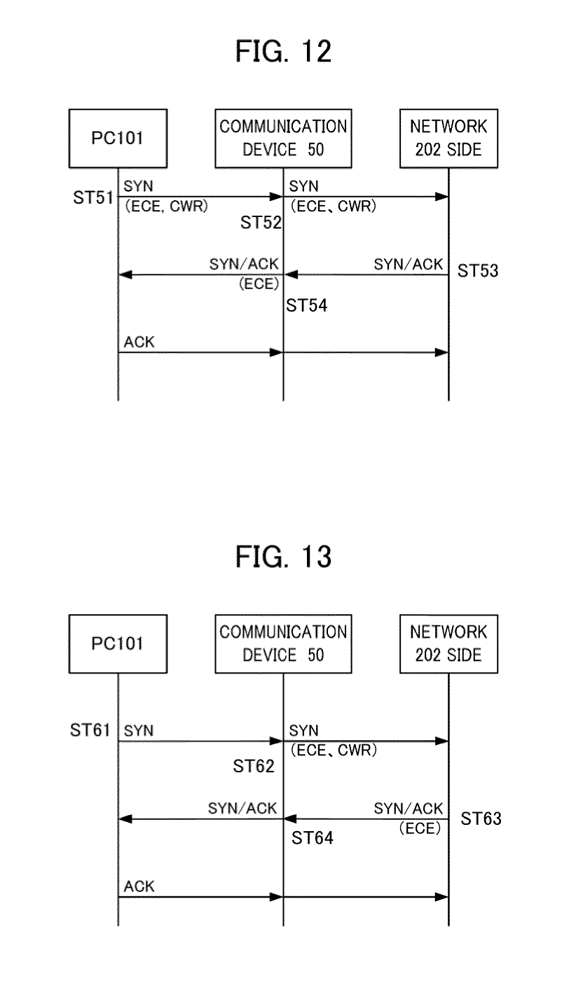

Here, a TCP connection establishment sequence in a case in which the PC 101 is compliant with ECN and the network 202 side is not compliant with ECN is described with reference to FIG. 12.

It should be noted that the network 202 side is a concept of devices connected to the network 202 including devices as transmission destination of the PC 101.

The PC 101 transmits an SYN (Synchronize) packet in order to perform TCP establishment (Step ST51).

An ECE flag and a CWR flag indicating compliance with ECN have been added to the SYN packet.

Moreover, the communication device 50 stores the fact that the PC 101 is compliant with ECN by way of the SYN packet, and transfers the packet to the network without in the current state (Step ST52).

In response to the transmitted SYN packet, the network 202 side transmits (returns) an SYN/ACK (SYN-Acknowledgement) packet (Step ST53).

Here, in a case in which the network 202 side is not compliant with ECN, an ECE flag is not added.

In addition, since the PC 101 supports ECN, the communication device 50 adds an ECE flag to the header of the packet returned from the network 202 side, and transmits the packet to the PC 101 so as to change its own ECN into an active state (Step ST54).

In other words, in three-way handshaking for TCP establishment, in a case in which an ECE flag has not been added to control bits of a header of a TCP/IP packet received from the network 202 side, the communication device 50 changes ECN of the communication device 50 into an active state “ON”, and adds an ECE flag to the control bits of the header so as to make it appear to the PC 101 as if the network 202 side has ECN, thereby changing ECN of the PC 101 into an active state.

Thereafter, ECN control is performed between the PC 101 and the communication device 50.

With such a configuration, the communication device 50 can make it appear to the PC 101 as if the network 202 side supports ECN.

Accordingly, after the TCP connection establishment sequence, data communication can be performed by way of ECN control between the PC 101 and the communication device 50.

### TCP Connection Establishment Sequence (5)

Next, a TCP connection establishment sequence in a case in which the PC 101 is not compliant with ECN and the network 202 side is compliant with ECN is described with reference to FIG. 13.

It should be noted that the network 202 side is a concept of devices connected to the network 202 including devices as transmission destination of the PC 101.

The PC 101 transmits an SYN packet in order to perform TCP establishment (Step ST61).

Since the PC 101 is not compliant with ECN in this sequence, an ECE flag and a CWR flag have not been added to the SYN packet.

In addition, the communication device 50 adds an ECE flag and a CWR flag to a header of an SYN packet, and transfers the packet to the network 202 side (Step ST62).

With this operation, the communication device 50 can make it appear to the network 202 side as if the PC 101 is compliant with ECN.

Furthermore, in response to the received SYN packet, the network 202 returns a reply packet for an SYN/ACK (SYN-Acknowledgement) packet (Step ST63).

An ECE flag indicating compliance with ECN has been added to the reply packet.

Moreover, since the PC 101 is not compliant with ECN, the communication device 50 removes the ECE flag from the header of the reply packet transmitted from the network 202, and transfers the packet to the PC 101 (Step ST64).

In other words, in three-way handshaking for TCP establishment, the communication device 50 can change a header of a TCP/IP packet received from the PC 101 to add an ECE flag, and make it appear to the network 202 side as if the PC 101 is compliant with ECN, thereby changing ECN of the network side into an active state.

Thereafter, ECN control is performed between the network 202 and the communication device 50.

It should be noted that, in a case in which both of the PC 101 and the network 202 side are not compliant with ECN, the communication device 50 operates so as to merely monitor the negotiation status and store whether ECN has become available. Operations of PC 101 When Congestion Occurs in Network 202 Side

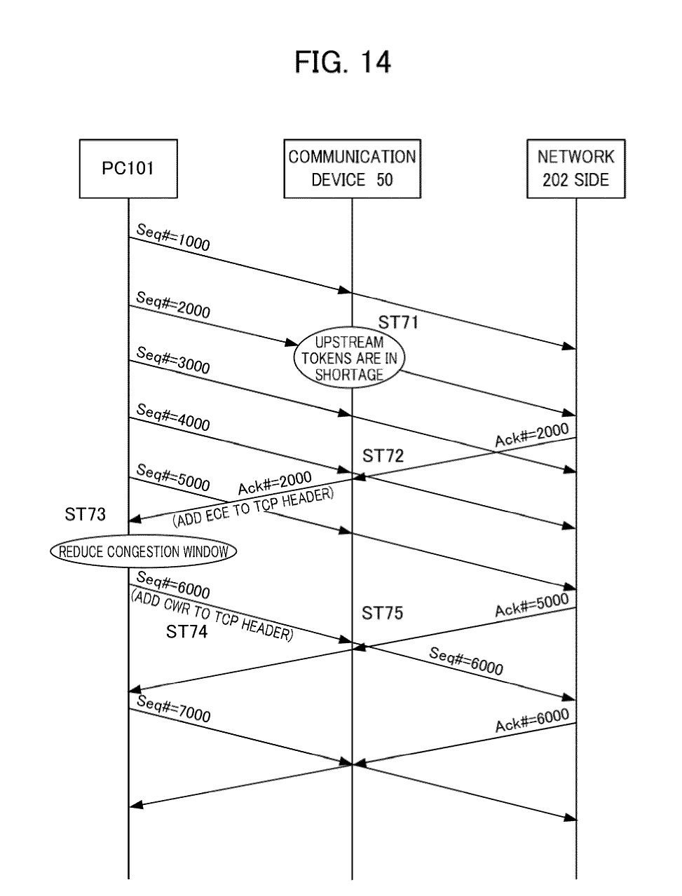

Next, operations of the PC 101 in a case in which congestion occurs in the network 202 side are described with reference to FIG. 14.

The communication device 50 detects that tokens for outputting upstream packets from the PC 101 to the network 202 side do not reach a predetermined amount, i.e. detects that the state of being no more than the second threshold value has continued for more than a predetermined time (Step ST71).

It should be noted that, in a case in which the tokens do not reach a predetermined amount, the communication device 50 can not output upstream packets to the network 202 side.

In a case in which the communication device 50 detects that the tokens do not reach a predetermined amount by way of the processing of Step ST71, the communication device 50 adds an ECE flag, which indicates that congestion has occurred, to a TCP header portion of the reply packet (Ack#=2000 in FIG. 14) that has been received thereafter from the network 202 side, and transfers the packet to the PC 101 (Step ST72).

Upon receiving the reply packet to which the ECE flag has been added, the PC 101 reduces the congestion window in accordance with ECN congestion control (Step ST73).

In addition, the PC 101 adds a CWR flag, which indicates that the congestion window has been reduced, to a TCP header of a transmission packet (Seq #=6000 in FIG. 14) to be output after reducing the congestion window (Step ST74).

The communication device 50 removes the CWR flag from the TCP header of the received transmission packet, and transfers the packet to the network 202 side (Step ST75).

In this way, in a case in which it has been confirmed that the PC 101 is compliant with ECN by way of the three-way handshaking, the communication device 50 can restrict the transmission rate of upstream packets even if the network 202 side is not compliant with ECN.

More specifically, the communication device 50 utilizes a token bucket mechanism for traffic control and a token rate, and in a case in which the tokens are in shortage, the communication device 50 performs congestion notification byway of ECN to the PC 101 side, and controls the transmission rate of the PC 101 side.

Operations of Network 202 Side When Congestion Occurs in PC 101

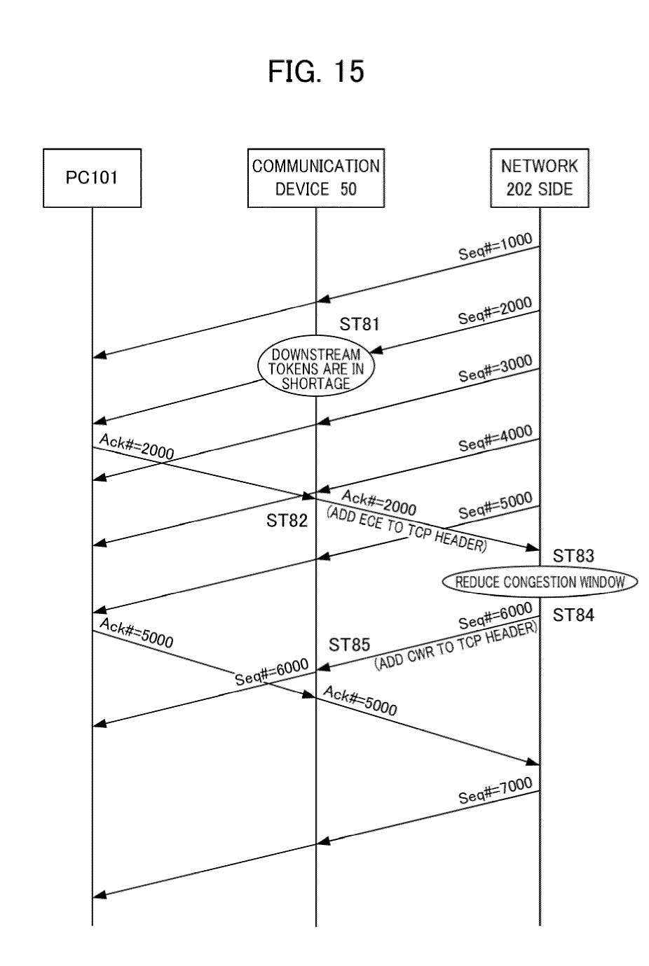

Next, operations of the network 202 side in a case in which congestion occurs in the PC 101 are described with reference to FIG. 15.

The communication device 50 detects that tokens for outputting downstream packets from the network 202 side to the PC 101 do not reach a predetermined amount, i.e. detects that the state of being no more than the second threshold value has continued for more than a predetermined time (Step ST81).

It should be noted that, in a case in which the tokens do not reach a predetermined amount, the communication device 50 can not output downstream packets to the PC 101.

In a case in which the communication device 50 detects that the tokens do not reach a predetermined amount by way of the processing of Step ST81, the communication device 50 adds an ECE flag, which indicates that congestion has occurred, to a TCP header portion of the reply packet (Ack#=2000 in FIG. 15) that has been received thereafter from the PC 101, and transfers the packet to the network 202 side (Step ST82).

Upon receiving the reply packet to which the ECE flag has been added, the network 202 side reduces the congestion window in accordance with ECN congestion control (Step ST83).

In addition, the network 202 side adds a CWR flag, which indicates that the congestion window has been reduced, to a TCP header of a transmission packet (Seq #=6000 in FIG. 15) to be output after reducing the congestion window (Step ST84).

The communication device 50 removes the CWR flag from the TCP header of the received transmission packet, and transfers the packet to the PC 101 (Step ST85).

In this way, in a case in which it has been confirmed that the network 202 side is compliant with ECN by way of the three-way handshaking, the communication device 50 can restrict the transmission rate of downstream packets even if the PC 101 is not compliant with ECN.

More specifically, the communication device 50 utilizes a token bucket mechanism for traffic control and a token rate, and in a case in which the tokens are in shortage, the communication device 50 performs congestion notification byway of ECN to the network 202 side, and controls the transmission rate of the network 202 side.

What is claimed is:

1. A communication device, comprising:
a first communication unit that is connected to an external device and relays data;
a second communication unit that transmits data received from the first communication unit to a network side, and transmits data received from the network side to the first communication unit; and
a processing unit that confirms whether a congestion control function against data congestion is provided to the external device to which the first communication unit is connected and an another party's device on the network side communicating with the second communication unit,
in a case in which any one of the devices has the congestion control function, and congestion is occurring in an other one of the devices, the control unit transmits control data for activating the congestion control function to the other one of the devices.

2. The communication device according to claim 1,
wherein the processing unit includes:
a first determination unit that determines whether the external device to which the first communication unit is connected and the another party's device on the network side communicating with the second communication unit have the congestion control function against data congestion, based on data received via the first communication unit and data received via the second communication unit;
a second determination unit that determines whether data congestion is occurring in the another party's device communicating with the second communication unit, based on data received via the second communication unit; and
a control unit that adds, to data transmitted via the first communication unit to the external device, first control data for activating the congestion control function provided to the external device, and causes the first communication unit to transmit the data, in a case in which the first determination unit determines that the device to which the first communication unit is connected has the congestion control function, but the another party's device communicating with the second communication unit does not have the congestion control function, and the second determination unit determines that data congestion is occurring in the another party's device communicating with the second communication unit.

3. The communication device according to claim 2,
wherein the first determination unit determines whether the external device to which the first communication unit is connected has the congestion control function based on whether the data received via the first communication unit includes information indicating that the congestion control function is provided, and determines whether the another party's device communicating with the second communication unit has the congestion control function based on whether the data received via the second communication unit includes information indicating that the congestion control function is provided.

4. The communication device according to claim 2,
wherein the second determination unit determines whether data congestion is occurring in the another party's device communicating with the second communication unit based on whether a timing of receiving data via the second communication unit is delayed for more than a predetermined time.

5. The communication device according to claim 3,
wherein the control unit deletes the information included in the data received via the first communication unit, the information indicating that the congestion control function is provided, and controls the second communication unit to transmit the data from which the information indicating that the congestion control function is provided has been deleted, in a case in which the first determination unit determines that the external device to which the first communication unit is connected has the congestion control function, and that the another party's device communicating with the second communication unit does not have the congestion control function.

6. The communication device according to claim 2,
wherein, after transmitting the first control data to the external device via the first communication unit, in a case in which the first communication unit has received, from the external device, second control data indicating that the congestion control function has been exercised, the control unit does not transmit the first control data when transmitting data via the first communication unit.

7. The communication device according to claim 2,
wherein, in a case in which the first determination unit determines that the external device to which the first communication unit is connected and the another party's device communicating with the second communication unit have the congestion control function, the control unit transmits data without changing the data, both in a case of transmitting the data received via the second communication unit to the external device to which the first communication unit is connected, and in a case of transmitting the data received via the first communication unit to the another party's device to which the second communication unit is connected.

8. The communication device according to claim 1, wherein the processing unit includes:
a first token generating unit that generates a token configured with a predetermined data amount;
a first token storing unit that stores the token;
a first detecting unit that detects an amount of tokens stored in the first token storing unit;
a first control unit that determines whether an amount of tokens detected by the first detecting unit has reached a first threshold value, and in a case in which the first control unit determines that the amount of tokens has reached the first threshold value, the first control unit controls such that the data received via the first communication unit is transmitted, for only an amount corresponding to the amount of tokens, to the network via the second communication unit; and
a first determination unit that determines whether the external device to which the first communication unit is connected has the congestion control function against data congestion,
wherein, in a case in which the first control unit determines that an amount of tokens detected by the first detecting unit is no more than a second threshold value, which is smaller than the first threshold value, and the first determination unit determines that the external device to which the first communication unit is connected has the congestion control function, the first control unit adds first control information for activating the congestion control function to data to be transmitted via the first communication unit, and causes the first communication unit to transmit the data.

9. The communication device according to claim 8, wherein the first determination unit determines whether the device to which the first communication unit is connected has the congestion control function, based on whether the data received via the first communication unit includes second control information indicating that the congestion control function is provided.

10. The communication device according to claim 8, wherein, in a case in which the first communication unit has received, from the external device connected thereto, data to which third control information has been added, indicating that a congestion window has been reduced, the first control unit deletes the third control information from the data, and transmits the data, from which the third control information has been deleted, to the network via the second communication unit.

11. The communication device according to claim 1, wherein the processing unit includes:
a second token generating unit that generates a token configured with a predetermined data amount;
a second token storing unit that stores the token;
a second detecting unit that detects an amount of tokens stored in the second token storing unit;
a second control unit that determines whether an amount of tokens detected by the second detecting unit has reached a first threshold value, and in a case in which the second control unit determines that the amount of tokens has reached the first threshold value, the first control unit controls such that the data received via the second communication unit is transmitted, for only an amount corresponding to the amount of tokens, to the network via the first communication unit; and
a second determination unit that determines whether the another party's device on the network side has the congestion control function against data congestion,
wherein, in a case in which an amount of tokens detected by the second detecting unit is no more than a second threshold value, which is smaller than the first threshold value, and the second determination unit determines that the another party's device on the network side has the congestion control function, the second control unit adds fourth control information for activating the congestion control function to the data received via the first communication unit, and causes the second communication unit to transmit the data.

12. The communication device according to claim 11, wherein the second determination unit determines whether the device on the network side has the congestion control function, based on whether the data received via the second communication unit includes fifth control information indicating that the congestion control function is provided.

13. The communication device according to claim 11, wherein, in a case in which the second communication unit has received, from the device on the network side, data to which sixth control information has been added, indicating that a congestion window has been reduced, the second control unit deletes the sixth control information from the data, and transmits the data, from which the sixth control information has been deleted, to the external device via the first communication unit.

14. A communication method for a communication device having a first communication unit and a second communication unit, comprising:
a relaying data from an external device connecting via the first communication unit;
a transmitting data received from the first communication unit to a network side via the second communication unit, and data received from the network side to the first communication unit; and
a processing that confirms whether a congestion control function against data congestion is provided to the external device to which the first communication unit is connected and an another party's device on the network side communicating with the second communication unit,
in a case in which any one of the devices has the congestion control function, and congestion is occurring in an other one of the devices, the processing unit transmits control data for activating the congestion control function to the other one of the devices.
